(19) United States
(12) Patent Application Publication
(10) Pub. No.: US 2023/0274370 A1
(43) Pub. Date: Aug. 31, 2023

(54) INSTANT TAX AND FEE COLLECTION AND DISTRIBUTION DIGITAL CURRENCY SYSTEM CONFIGURED TO INSTANTLY COLLECT AND DISTRIBUTE TAXES AND/OR FEES IN TRANSFER PROVIDING AUTOMATIC MUNICIPAL, STATE, AND/OR FEDERAL TAXES, PAYROLL TAXES, AND/OR FEES INSTANT PAYMENT ELIMINATING BACK DUE TAXES AND FUTURE PROPERTY TAXES

(71) Applicant: Darren Andrew Lyman, Lakewood, CO (US)

(72) Inventor: Darren Andrew Lyman, Lakewood, CO (US)

(21) Appl. No.: 17/733,838

(22) Filed: Apr. 29, 2022

Related U.S. Application Data
(60) Provisional application No. 63/314,246, filed on Feb. 25, 2022.

(51) Int. Cl. G06Q 40/00; G06Q 20/36; G06Q 40/04

(52) U.S. Cl. CPC G06Q 40/10; G06Q 20/36; G06Q 40/04; G06Q 40/123

(57) ABSTRACT

An instant tax collection digital currency system is disclosed that is configured for instant tax collection. This can eliminate back taxes due, future property taxes and/or fees by enabling instant digital currency automated payments to occur. The instant tax collection digital currency system is configured to perform instant and automatic sales tax, income tax, and/or property tax collections. The instant tax collection digital currency system can be configured to perform quarterly payments with instant and automatic tax and/or fee collection. In this way, the instant tax collection digital currency system eliminates back taxes due, future property taxes and/or fees, thereby helping the community, business growth and providing an investment opportunity.

### BACKGROUND

This application claims benefit to U.S. Provisional Patent Application 63/314,246, entitled “AN INSTANT TAX AND FEE COLLECTION AND DISTRIBUTION DIGITAL CURRENCY SYSTEM CONFIGURED TO INSTANTLY COLLECT AND DISTRIBUTE TAXES AND/OR FEES IN TRANSFER PROVIDING AUTOMATIC MUNICIPAL, STATE, AND/OR FEDERAL TAXES, PAYROLL TAXES, AND/OR FEES INSTANT PAYMENT ELIMINATING BACK DUE TAXES AND FUTURE PROPERTY TAXES,” filed Feb. 25, 2022. The U.S. Provisional Patent Application 63/314,246 is incorporated herein by reference.

### BACKGROUND

Embodiments of the invention described in this specification relate generally to sales and property tax payment and collection systems, and more particularly, to an instant tax collection digital currency system that is configured for instant tax collection and which eliminates back taxes due and future property taxes and/or fees by enabling digital currency automated payments to occur.

Current sales tax collections mechanisms (by each State) typically involve arduous and manual cash money type transactions. A common result is sales tax not being paid timely, resulting in back taxes. This leaves States in the precarious position of having to go after and collect back taxes. Furthermore, property taxes are collected by States typically on payor's own initiative. Say a property owner does not pay property taxes in a timely fashion. Now the State needs to treat the delinquent payments as back taxes and make efforts to collect the original property taxes and additional penalty fees. While there are many tax payers who voluntarily pay their taxes timely, sometimes even the willing tax payers forget to pay on time for a lot of reasons, such as not having a checkbook handy and just forgetting, not making a trip to post the payment, thinking some payment was made when it was not, etc.

Therefore, what is needed is an alternative manner of collecting tax payments and making tax payments by property and business owners, such that payments can be automated and back tax collections can be eliminated.

### BRIEF DESCRIPTION

An instant tax collection digital currency system is disclosed which is configured to provide an instant tax and/or fee collection mechanism integrated with a digital currency as legal tender for payment of taxes and/or fees. In some embodiments, a process for creating and configuring a digital currency system is performed to initiate an instant tax collection digital currency system for deployment by a jurisdictional tax collecting entity to instantly collect taxes and/or fees and distribute tax and fee revenues for a variety of community needs within the jurisdiction. Upon creation, the instant tax collection digital currency system can be deployed by the jurisdictional tax collecting entity (e.g., a State government tax collection agency or entity) to collect and eliminate back taxes due, future property taxes and/or collect fees by enabling automated digital currency payments to occur. In some embodiments, the instant tax collection digital currency system is configured to perform instant and automatic sales tax, income tax, and property tax collections. In some embodiments, the instant tax collection digital currency system is configured to perform quarterly payment and instant/automatic tax and/or fee collection. In this way, the instant tax collection digital currency system eliminates back taxes due and future property taxes, thereby helping business growth and providing an investment opportunity.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for creating and configuring an instant tax collection digital currency system for deployment by a jurisdictional tax collecting entity to instantly collect taxes and/or fees and distribute tax and fee revenues for a variety of community needs within the jurisdiction in some embodiments.

FIG. 2 conceptually illustrates a block diagram of an instant tax collection digital currency system that is configured to automatically and instantly collect taxes and fees on peer to peer digital currency transactions in some embodiments.

FIG. 3 conceptually illustrates a block diagram of different types of peer to peer sales taxed transactions in some embodiments.

FIG. 4 conceptually illustrates a block diagram of different types of peer to peer sales tax exempt transactions in some embodiments.

FIG. 5 conceptually illustrates a block diagram that demonstrates an example flow of a sales taxed transactions in some embodiments.

FIG. 6 conceptually illustrates a block diagram that demonstrates an example Federal payroll tax flow in some embodiments.

FIG. 7 conceptually illustrates a block diagram that demonstrates an example Federal payroll tax digital currency flow in some embodiments.

FIG. 8 conceptually illustrates digital currency wallet configurations that may be implemented for different deployments of the instant tax collection digital currency system in some embodiments.

FIG. 9 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

In this specification, the term “digital currency” refers to a non-fiat currency that may be used in connection with a blockchain with cryptographically encoded digital currency transactions stored as block of the blockchain or may be used in connection with another type of ledger system absent a blockchain implementation. Also, the term “digital currency” is variously referred to as “crypto currency” in this specification.

The term “digital currency token” refers to a single base monetary unit of value for the digital currency. Also, the term “digital currency token” is variously referred to as “token”, “digital token”, “crypto token”, and/or “crypto coin” in this specification.

An instant tax collection digital currency system of some embodiments is configured to provide an instant tax and/or fee collection mechanism integrated with a digital currency as legal tender for payment of taxes and/or fees. In some embodiments, a process for creating and configuring a digital currency system is performed to initiate an instant tax collection digital currency system for deployment by a jurisdictional tax collecting entity to instantly collect taxes and/or fees and distribute tax and fee revenues for a variety of community needs within the jurisdiction. Upon creation, the instant tax collection digital currency system can be deployed by the jurisdictional tax collecting entity (e.g., a State government tax collection agency or entity) to collect and eliminate back taxes due, future property taxes and/or collect fees by enabling automated digital currency payments to occur. In some embodiments, the instant tax collection digital currency system is configured to perform instant and automatic sales tax, income tax, and property tax collections. In some embodiments, the instant tax collection digital currency system is configured to perform quarterly collection and instant/automatic tax and/or fee collection. In this way, the instant tax collection digital currency system eliminates back taxes due and future property taxes, thereby helping business growth and providing an investment opportunity in digital currency.

As stated above, current sales tax collections mechanisms (by each State) typically involve arduous and manual cash money type transactions. A common result is sales tax not being paid timely, resulting in back taxes. This leaves States in the precarious position of having to go after and collect back taxes. Furthermore, property taxes are collected by States typically on payor's own initiative. Say a property owner does not pay property taxes in a timely fashion. Now the State needs to treat the delinquent payments as back taxes and make efforts to collect the original property taxes and additional penalty fees. While there are many tax payers who voluntarily pay their taxes timely, sometimes even the willing tax payers forget to pay on time for a lot of reasons, such as not having a checkbook handy and just forgetting, not making a trip to post the payment, thinking some payment was made when it was not, etc. Embodiments of the instant tax collection digital currency system described in this specification solve such problems by incentivizing and simplifying (by automation) tax payment systems with a digital currency (or “crypto”) token that works as legal tender in connection with the digital currency system of the present disclosure.

Embodiments of the instant tax collection digital currency system described in this specification differ from and improve upon currently existing options. In particular, some embodiments differ by being able to perform instant tax collection for sales tax, quarterly tax collection automated for income taxes and social security taxes, and other automated collection of taxes and/or fees.

The instant tax collection digital currency system of the present disclosure may be comprised of the following elements. This list of possible constituent elements is intended to be exemplary only and it is not intended that this list be used to limit the instant tax collection digital currency system of the present application to just these elements. Persons having ordinary skill in the art relevant to the present disclosure may understand there to be equivalent elements that may be substituted within the present disclosure without changing the essential function or operation of the instant tax collection digital currency system.

1. Create crypto token that can be used with system and stored in digital wallets

2. Integrate the crypto token as legal tender and payment of taxes and/or fees

3. Deploy the system hardware and software-based processes

4. Integrate the system (including hardware, software, and other technology resources and systems) with tax and/or fees collection agency (or other jurisdictional authority) systems

The various elements of the instant tax collection digital currency system of the present disclosure may be related in the following exemplary fashion. It is not intended to limit the scope or nature of the relationships between the various elements and the following examples are presented as illustrative examples only. Digital currency in the form of “crypto” tokens with tax and/or fees built into transfer, stored in digital wallets of owners. The various types of wallets would need to support include, without limitation, exchange, business, retail, individual, non-profit organization, state, municipal, and federal, among others.

The instant tax collection digital currency system of the present disclosure generally works by a process of instant automatic tax and/or fee deduction in transfers between wallets. For instance, the system can be configured to require 3% State tax sent automatically sent to state wallet, 5% Municipal tax sent automatically to municipality based on wallet zip code, 1% Property tax fee collected instantly sent to state wallet, 1% Proportionate holder split fee distributed instantly to individual, business and exchange wallets. Percentages and quantity may vary. In this way, it is possible to eliminate back taxes due and residential property taxes. The fees and taxes collected can then be used to alleviate future residential property taxes until eliminated, provide low to no income permanent housing solutions, provide land for community gardening solutions, enhance public schools, community centers and land, and/or enhance wildlife refuge and land recovery.

To make the instant tax collection digital currency system of the present disclosure, a digital currency platform would be created, integrated, and deployed as a central component, with crypto tokens, wallets, exchanges, possible smart contracts implemented with alternate blockchain networks, etc., and may also be integrated with existing tax and/or fee collections software systems of jurisdictional agencies or entities, whether State, Federal, Municipal, and/or other (hereinafter also referred to as the jurisdiction's “tax and/or fees collections entity”).

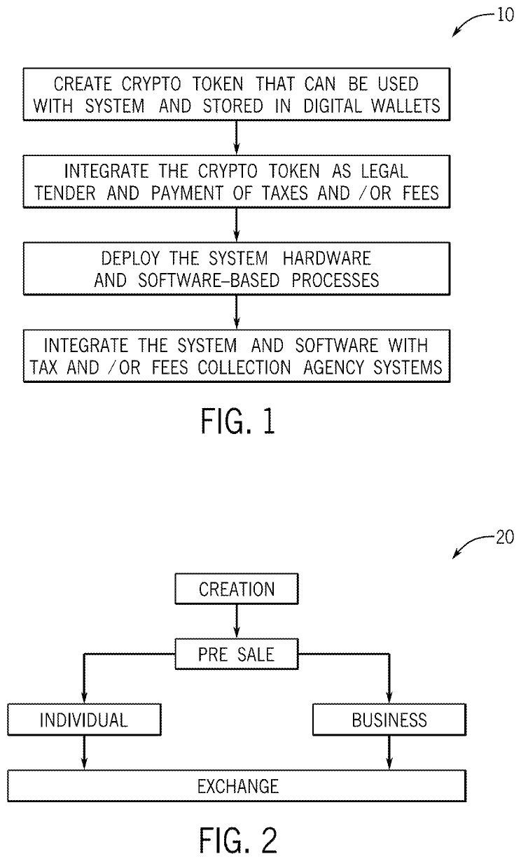

By way of example, FIG. 1 conceptually illustrates a process 10 for creating and configuring an instant tax collection digital currency system for deployment by a jurisdictional tax collecting entity to instantly collect taxes and/or fees and distribute tax and fee revenues for a variety of community needs within the jurisdiction in some embodiments. As shown in this figure, the process 10 starts by creating a crypto token that can be used with an instant tax collection digital currency system to be deployed and integrated by the tax and/or fees collections entity for the jurisdiction. In addition to ensuring that the crypto token can be used with the instant tax collection digital current system to be deployed and integrated by the tax and/or fees collections entity for the jurisdiction, the process 10 ensures that the crypto token being created is capable of being stored in digital wallets that users of the instant tax collection digital currency system utilize to hold their tokens. In some embodiments, the crypto tokens are created as fungible tokens based on a specification for fungible digital currencies and may include smart contract features or other features. In some embodiments, the crypto token is created in connection with a blockchain implementation that is configured to track transactions involving the crypto tokens by users for sales transactions and tracking of sales taxes, payroll taxes, property taxes due, late property tax payments, fees, such as as fees for water, sewage, waste removal, fees due for licensing (e.g., business license, hazardous waste handling license, and/or other licenses required by the jurisdiction), fees for penalties or fines, etc.

After creating the crypto token capable of being used with the instant tax collection digital currency system and being stored in digital wallets of users, the process 10 moves to the next step of integrating the crypto token as legal tender and for payment of taxes and/or fees. In some embodiments, a fiat currency exchange is required to integrate the crypto token as legal tender/payment of taxes and/or fees. In some embodiments, the crypto token is integrated as legal tender/payment of taxes and/or fees without a fiat currency exchange or with only an optional fiat currency exchange

Next, the process deploys the hardware and software-implemented processes for the instant tax collection digital currency system. For example, an information technology unit of a jurisdiction by provision and deploy computer servers, networking and communication hardware systems, database management servers and database software systems that are installed and run on storage devices in secure, local configurations and/or in cloud-based private storage locations for the jurisdiction. A variety of new and previously existing computing, networking, storage, and communication hardware resources not mentioned above may also be provisioned and deployed, as needed by the jurisdiction to support the instant tax collection digital currency system.

Finally, the process 10 proceeds to a step for integrating the instant tax collection digital currency system (with its hardware and software resources) with existing tax and/or fee collection systems that are already deployed and have been utilized previously by the respective departments, units, and/or agencies of the respective jurisdiction in which the instant tax collection digital currency system is being created and deployed.

After creation and deployment of the instant tax collection digital currency system, with the crypto token integrated as legal tender for peer to peer transactions (e.g., between different persons or from person to business, or business to person, etc.) and/or for payment of taxes and/or fees, a model of the instant tax collection digital currency system is captured. An example of such as model for an instant tax collection digital currency system deployment is described next, by reference to FIG. 2.

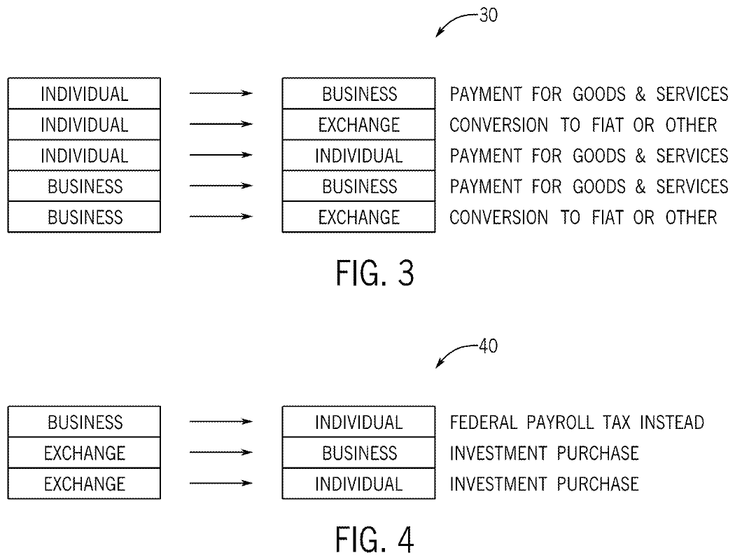

Specifically, FIG. 2 conceptually illustrates a block diagram of an instant tax collection digital currency system model 20 that is configured to automatically and instantly collect taxes and fees on peer to peer digital currency transactions in some embodiments. As shown in this figure, the instant tax collection digital currency system model 20 includes a block for creation of the instant tax collection digital currency system (“CREATION”), which is described above, by reference to FIG. 1. After creation and deployment, the instant tax collection digital currency system model 20 provides a block for sales configuration prior to a sale (“PRE-SALE”). The PRE-SALE block includes different peer entities recognized as transacting entities liable for payment of taxes and/or fees by the instant tax collection digital currency system. One peer entity shown in the instant tax collection digital currency system model 20 is for individual persons (“INDIVIDUAL”) and another peer entity is for businesses and other organizations (“BUSINESS”). A block for exchanges of crypto tokens (“EXCHANGE”) is also shown in the instant tax collection digital currency system model 20. The EXCHANGE block represents exchanges of crypto tokens between the INDIVIDUAL and the BUSINESS, INDIVIDUAL and (other) INDIVIDUAL, BUSINESS and (other) BUSINESS, INDIVIDUAL and EXCHANGE, and/or BUSINESS and EXCHANGE. Thus, the EXCHANGE block is a foundational block upon which the instant tax collection digital currency system is built in support of expected peer to peer transactions (e.g., sales transactions, payroll distributions, business service fees payment, exchanges to fiat currencies or from fiat currencies into cryto tokens, etc.), as these transactions are connected through the EXCHANGE block underlying the instant tax collection digital currency system. This is further demonstrated next, by reference to FIG. 3.

Specifically, FIG. 3 conceptually illustrates a block diagram of different types of peer to peer sales taxed transactions 30 in some embodiments. As shown in this figure, the different types of peer to peer sales taxed transactions 30 include (i) individual to business in connection with payment for goods and services, (ii) individual to exchange for conversion of crypto tokens to fiat currency or other value, (iii) individual to individual for payment of goods and services, (iv) business to business for payment of goods and services, and (v) business to exchange for conversion to fiat currency or other value.

Turning to another view, FIG. 4 conceptually illustrates a block diagram of different types of peer to peer sales tax exempt transactions 40 in some embodiments. As shown in this figure, the different types of peer to peer sales tax exempt transactions 40 include (i) business to individual transactions (in which the tax system of the jurisdiction may rely instead of Federal payroll taxes instead of taxes levied on business to individual transactions), (ii) exchange to business, such as for investment purchases, and (iii) exchange to individual (for investment purchases).

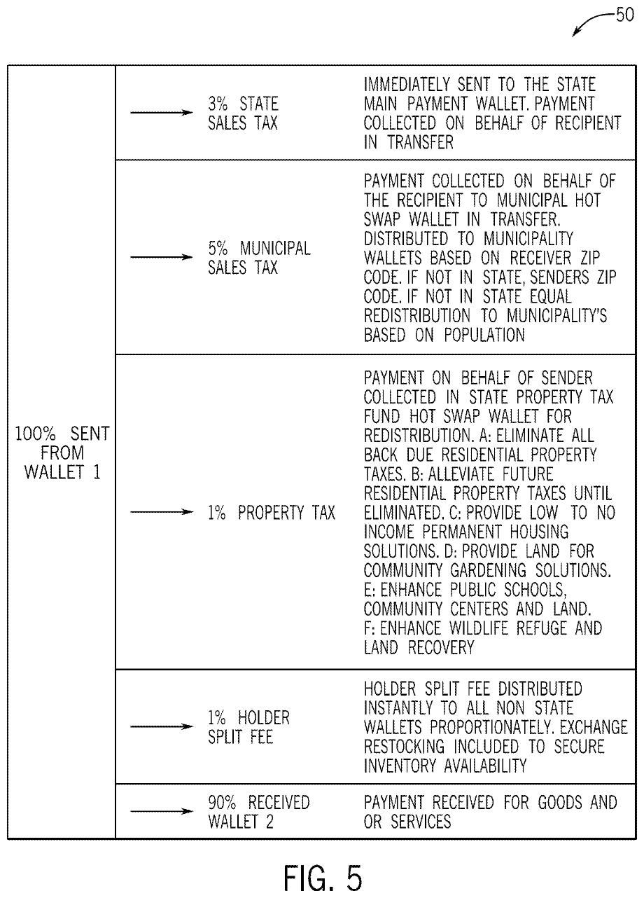

By way of example, FIG. 5 conceptually illustrates a block diagram that demonstrates an example flow of a sales taxed transactions 50 in some embodiments. As shown in this figure, the example flow of a sales taxed transactions 50 demonstrates the instant tax implications under the instant tax collection digital currency system of a peer to peer transaction in which a first peer entity is associated with a first digital wallet (“WALLET 1”) who pays a second peer entity associated with a second digital wallet (“WALLET 2”) for goods or services rendered. Specifically, 100% of the payment is made from WALLET 1 to the exchange underlying the instant tax collection digital currency system with the intention of payment to WALLET 2.

When the payment from WALLET 1 is made, three percent (3%) of the payment amount is automatically and instantaneously transferred to a state main payment digital wallet in connection with a 3% State sales tax. Payment is also collected on behalf of recipient in transfer. Then payment is automatically and instantly collected on behalf of the recipient to a municipal hot swap digital wallet in transfer. The municipal hot swap payment collected is five percent (5%) in this case, due to the 5% municipal sales tax in place. This is distributed to a particular municipality digital wallet based on the receiver zip code (that is, the zip code of the peer entity associated with WALLET 2). However, if the zip code is not in the State of original for the transaction, then the sender's zip code is used (that is, the zip code of the peer entity associated with WALLET 1). Furthermore, if the sender's zip code is not with the State of the original transaction (e.g., an individual with WALLET 1 visiting the State temporarily and making a digital online transaction to buy some commercial goods from a business with WALLET 2 from another State—meaning both peer entity for WALLET 1 and peer entity for WALLET 2 are out of state entities), then an equal distribution of the 5% municipal sales tax amount is automatically calculated for redistribution to all municipalities of the State based on population.

Also, when the payment from WALLET 1 to WALLET 2 is made, one percent (1%) property tax is levied where payment on behalf of the sender (WALLET 1) is collected in a State property tax fund hot swap digital wallet for redistribution in any of several manners. For example, redistribution may be intended to (A) eliminate all back due residential property taxes, (B) alleviate future residential property taxes until eliminated, (C) provide low-to-no income permanent housing solutions, (D) provide land for community gardening solutions, (E) enhance public schools, community centers, and land, and/or (F) enhance wildlife refuge and land recovery. Another one percent (1%) holder split fee is automatically and instantaneously distributed to all non-State wallets proportionately. Exchange restocking is included in this distribution to secure inventory available. Adding up the aforementioned automatic and instantaneous distributions of 3% State sales tax, 5% municipal sales tax, 1% property tax, and 1% holder split fee leaves a balance of 90% of the amount sent from WALLET 1 being received at WALLET 2 for payment of the good and/or services rendered.

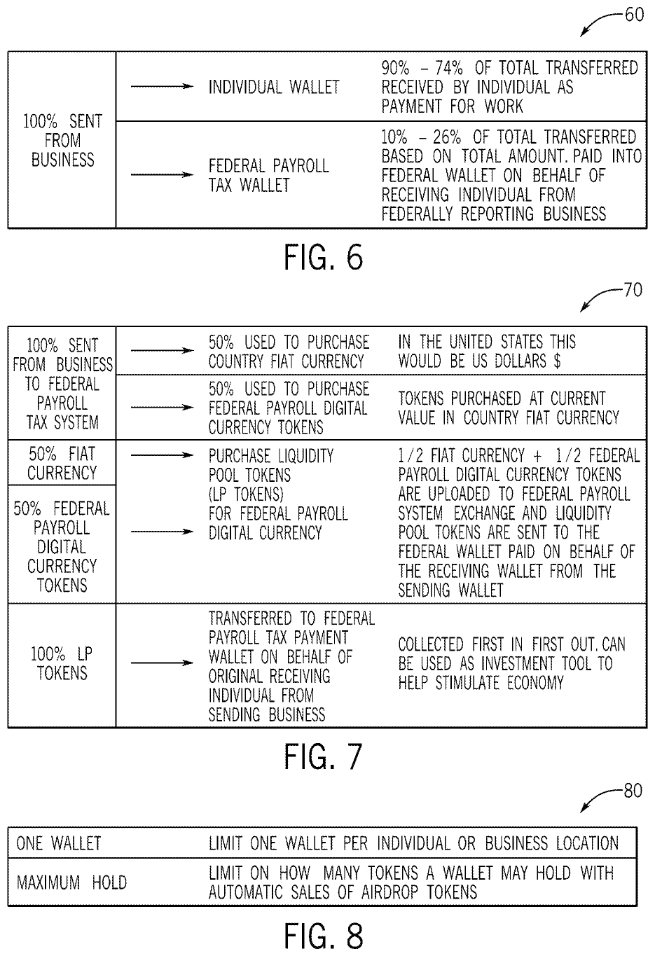

By way of example, FIG. 6 conceptually illustrates a block diagram that demonstrates an example Federal payroll tax flow 60 in some embodiments. As shown in this figure, an entire, one-hundred percent (100%) amount is paid from a business peer entity an individual peer entity for payment of salaried or hourly work by the individual. In this case, being a business payroll payment, the instant tax collection digital currency system automatically and instantaneously splits the entire 100% amount between the individual and Federal payroll tax entity. Specifically, a digital wallet of the individual receives seventy-four to ninety percent (74% to 90%) of the entire 100% amount transferred as payment for the work rendered by the individual to the business. The range is spread from 74% to 90% based on Federal payroll tax charts based on projected income and other factors for the individual. Accordingly, the instant tax collection digital currency system automatically and instantaneously transfers the remaining ten to twenty-six percent (10% to 26%) to the Federal payroll tax digital wallet, depending on the amount actually paid to the individual. Also, this may be paid into the Federal payroll tax digital wallet on behalf of the receiving individual from a Federally reporting business.

By way of another example, FIG. 7 conceptually illustrates a block diagram of an exemplary Federal payroll tax digital currency flow 70 in some embodiments. As shown in this figure, the Federal payroll tax digital currency flow 70 demonstrates, in three rows, how the instant tax collection digital currency system breaks down between fiat currency payments and crypto tokens payments. In the first (top) row, a full amount of one-hundred percent (100%) is sent from a business to the Federal payroll tax system. This is distributed with fifty percent (50%) being used to purchase fiat currency in the country of origin. For example, the business is American and pays into the United States Federal payroll tax system, so 50% of the amount is used to purchase U.S. dollars. The remaining 50% is used to purchase Federal payroll digital currency tokens (at the current value in the country's fiat currency).

In the second row, half of the total payment amount (50%) is in fiat currency and the other half is made in Federal payroll digital currency tokens. The 50% paid in fiat currency is used to purchase liquidity pool tokens (“LP tokens”) for Federal payroll. The remaining 50% paid in Federal payroll digital currency tokens is received as digital currency tokens. This means that half can be in fiat currency while the other half in Federal payroll digital currency tokens are uploaded to the Federal payroll tax system exchange and LP tokens are sent to the Federal digital wallet paid on behalf of the receiving wallet from the sending wallet.

In the third row, 100% are paid in as LP tokens, which are transferred to the Federal payroll tax payment wallet on behalf of the original receiving individual from the sending business. This is collected in a first-in-first-out (FIFO) basis and can be used as an investment tool to help stimulate the economy.

While many of the examples described above, by reference to FIGS. 1-7, involve digital currency wallets, FIG. 8 conceptually illustrates digital currency wallet configurations 80 that may be implemented for different deployments of the instant tax collection digital currency system in some embodiments. As shown in this figure, the digital currency wallet configurations 80 include a one wallet configuration and a maximum hold configuration. Under the one wallet configuration, there is a limit of one digital wallet per individual or business location used in connection with the instant tax collection digital currency system. Under the maximum hold configuration, there is a limit on how many crypto tokens any given digital wallet may hold with automatic sales of airdrop tokens or the like.

To use the instant tax collection digital currency system of the present disclosure, a person can simply pay for products, services, or taxes via digital wallet and crypto tokens, which are automatically designed to distribute the appropriate proportion of taxes to the current collecting agency, whether State, Federal, Municipal, and/or other. Since transactions are completed at the behest of the owner of the token, the automated collection of tax and/or fees simplifies the requirements for all parties involved in the transaction.

Many of the above-described features and applications are implemented as software processes that are specified as a set of instructions recorded on a computer readable storage medium (also referred to as computer-readable storage media, machine-readable media, machine-readable storage media, or non-transitory computer readable media). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the terms “software”, “application”, “program”, etc. (referred to below as “software”) are meant to include firmware residing in read-only memory or applications stored in magnetic storage, which can be read into memory for processing by a processor of electronic system hardware or computer system hardware (referred to as “electronic system”), such as the processor of a State or Federal tax server system (also referred to as a “server”) or computing device (referred to as a “traditional computer”, or simply as a “computer”). Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

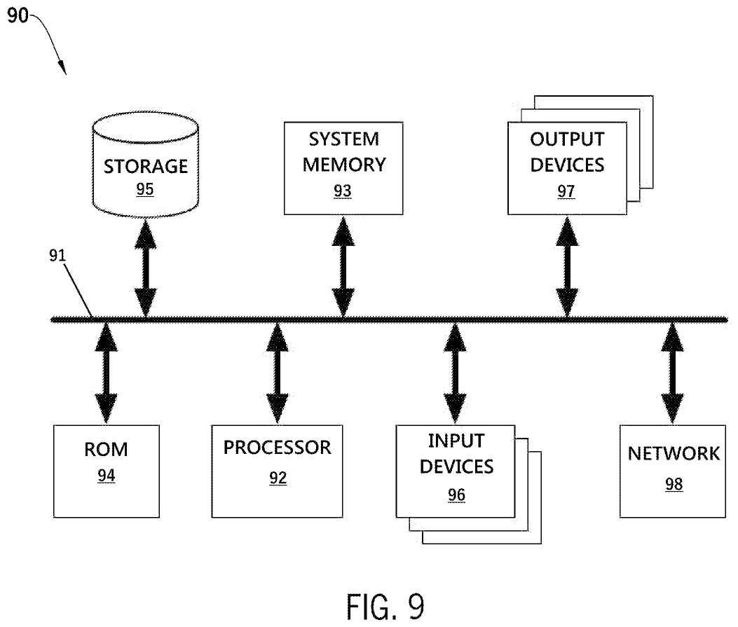

FIG. 9 conceptually illustrates an electronic system 90 with which some embodiments of the invention are implemented. The electronic system 90 may be a computer, a server, one or more networked single board computers that combine to form a computer system, or any other sort of electronic device, which may include software implemented processes and instructions for carrying out operations commensurate with the actions of the invention. Such an electronic system includes various types of computer readable media and interfaces for various other types of computer readable media. Specifically the electronic system 90 shown in this figure includes a bus 91, processing unit(s) 92, a system memory 93, a read-only memory 94, a permanent storage device 95, input devices 96, output devices 97, and a network 98.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. An instant tax collection digital currency system comprising:
a crypto token as legal tender that can be used for sales transactions, tax payments, and fee payments and is capable of being stored in digital wallets of tax payers, wherein the crypto token is integrated into tax and fee collections systems and deployed by a tax and fee collections entity in a particular jurisdiction;
a blockchain that implements the crypto token and is configured to track payment transactions that involve payment by the crypto tokens for sales transactions, tax payments, and fee payments, wherein the blockchain is accessible via networking and communication hardware systems managed by information technology units of the particular jurisdiction, wherein the tax payment transactions tracked by the blockchain comprise tax payments for sales taxes associated with the sales transactions, tax payments for payroll taxes, tax payment amounts due for property taxes due, and late tax payments for late property tax payments, wherein the fee payment transactions tracked by the blockchain comprise fee payments for water, fee payments for sewage, fee payments for waste removal, fee payments for licensing fees due, fee payments for penalties, and fee payments for fines;
a smart contract that allocates a proportion of crypto token payments for tax and fee collection;
a tax distribution system that runs a database management server and is configured to automatically collect and account for taxes and fees paid, by storage of records for payment amounts in a database managed by the database management server, including transactions paid by crypto tokens and tracked in the blockchain;
integration with tax and fee collection jurisdictional authority system, wherein the jurisdictional authority system comprises computer servers, networking and communication hardware systems, and database software systems that are installed and run on storage devices in a secure, local configuration within the particular jurisdiction, and
an exchange sub-system through which crypto tokens are transferred between different peer entities, wherein the exchange sub-system is configured to exchange the crypto tokens for money in any of a plurality of different fiat currencies, wherein the different peer entities transferring crypto tokens comprise (i) a first individual user transferring a first crypto token to a first business in exchange for money in a particular fiat currency in the plurality of different fiat currencies that transfer crypto tokens, (ii) a second business transferring a second crypto token to a second individual user in exchange for money in the particular fiat currency, and (iii) a third individual user transferring a third crypto token to a third business in exchange for a commercial product from the business, wherein the commercial product is valued at a particular amount in the particular fiat currency, wherein each of the first individual user and the first business, the second business and the second individual user, and the third individual user and the third business transfer the crypto tokens in exclusive secure peer-to-peer transactions.

2. (canceled)

3. (canceled)

4. (canceled)

5. (canceled)

6. The instant tax collection digital currency system of claim 1, wherein the exchange sub-system presents an exchange rate for each crypto token, wherein the particular amount in the particular fiat currency is used to calculate a number of crypto tokens required to complete the peer-to-peer transaction to purchase the commercial product from the business and make a tax payment for the completed transaction, wherein the number of crypto tokens comprises the third crypto token.

7. The instant tax collection digital currency system of claim 6, wherein the tax distribution system automatically and instantaneously allocates a percentage of the particular amount as the tax payment for the peer-to-peer transaction.

8. The instant tax collection digital currency system of claim 7, wherein the percentage of the particular amount comprises a first portion of the percentage automatically and instantly allocated to a first jurisdictional entity and a second portion of the percentage automatically and instantly allocated to a second jurisdictional entity.

9. The instant tax collection digital currency system of claim 8, wherein the first jurisdictional entity comprises a State tax system and the first portion comprises a three percent state tax, wherein the second jurisdictional entity comprises a municipality and the second portion comprises a five percent municipal tax, wherein the percentage of the particular amount further comprises a third portion of the percentage amounting to one percent automatically and instantly allocated to property taxes and toward low and no income housing, and a fourth portion of the percentage amounting to one percent automatically and instantly split between all holders.

10. The instant tax collection digital currency system of claim 9, wherein the State tax system comprises a State tax digital wallet the receives that first portion of the percentage of the number of crypto tokens paid, wherein the municipality comprises a particular municipal digital wallet that receives the second portion of the percentage of the number of crypto tokens paid.

11. The instant tax collection digital currency system of claim 1, wherein the tax distribution system is configured to integrate digital wallets of tax payers based on locations of the tax payers in a particular jurisdiction, wherein token transfers between wallets in the particular jurisdiction are transferred by routing the tokens based on the locations of the token-transferring wallets.

12. The instant tax collection digital currency system of claim 1, wherein the fee payments for licensing fees due comprise fee payments for business licenses, fee payments for hazardous waste handling licenses, and fee payments for licenses required by the particular jurisdiction.

13. A process for creating and configuring an instant tax collection digital currency system for deployment by a jurisdictional tax collecting entity to instantly collect taxes and fees and distribute tax and fee revenues for a variety of community needs within the jurisdiction, said process comprising:
creating a crypto token that is integrated as legal tender by a fiat currency exchange and can be used with an instant tax collection digital currency system to be deployed and integrated by a tax and fees collections entity of a jurisdiction;
ensuring that the crypto token is created with a capability of being stored in digital wallets of users paying at least one of taxes and fees to the tax and fees collections entity of the jurisdiction;
ensuring that the crypto token is created as a fungible currency that is exchangeable to a fiat currency used in the jurisdiction, wherein monetary funds in the fiat currency resulting from the exchange of the crypto token are allocated to the tax and fees collections entity for distribution of at least two percent to low incoming housing solutions, no income housing solutions, and public enhancement of community centers and public land, wherein the monetary funds in the fiat currency resulting from the exchange of the crypto token are further allocated to the tax and fees collections entity for distribution of a first percentage tax to a state tax fund and a second percentage tax to a municipal tax fund associated with the jurisdiction;
integrating the crypto token as legal tender for payments of taxes and fees to the tax and fees collections entity of the jurisdiction;
deploying hardware and software-implemented resources at physical locations for operating the instant tax collection digital currency system by an information technology unit of the jurisdiction; and
integrating the instant tax collection digital currency system and the hardware and software-implemented resources with an existing tax and fee collection system of the jurisdiction.

14. (canceled)

15. The process of claim 13, wherein the hardware and software-implemented resources comprise computer servers, networking and communication hardware systems, database management servers and database software systems that are installed and run on storage devices in one or more of (i) secure, local configurations and (ii) cloud-based private storage locations for the jurisdiction.
